(19) United States
(12) Patent Application Publication
(10) Pub. No.: US 2009/0268483 A1
(43) Pub. Date: Oct. 29, 2009

(54) ILLUMINABLE MARKING DEVICE

(75) Inventor: Kevin G. Donahue, Harvard, MA (US)

Correspondence Address: R.D. JOHNSON & ASSOCIATES, P.C., 20 PICKERING STREET, P.O.BOX 920353, NEEDHAM, MA, 02492, US

(73) Assignee: DONAHUE INVENTIONS LLC, Leominster, MA (US)

(21) Appl. No.: 12/421,626

(22) Filed: Apr. 9, 2009

Related U.S. Application Data
(63) Continuation-in-part of application No. 10/988,714, filed on Nov. 15, 2004.
(60) Provisional application No. 61/043,498, filed on Apr. 9, 2008.

(51) Int. Cl. F21V 8/00; B32B 37/02; B32B 37/12

(52) U.S. Cl. 362/602; 362/627; 156/60; 156/326

(57) ABSTRACT

An illuminable marking device includes a light guide panel overlaid with an illuminable pressure-sensitive film. Light is injected into the light guide panel at an angle of incidence sufficient to establish total internal reflection of the light between the surfaces of the light guide panel. When pressure is applied at selected points on the illuminable pressure-sensitive film, contact points on the film then interface with the light guide panel. The total internal reflection of light at that contact point is frustrated, allowing light to be extracted from the light guide panel and transmitted into the illuminable pressure-sensitive film. The viewer then sees illumination at the selected points. The illuminable marking device can be toy where children can create illuminated markings and drawings.

### RELATED APPLICATIONS

This application claims the benefit of U.S. Provisional Application No. 61/043,498, filed on Apr. 9, 2008 by Kevin G. Donahue; and is a continuation-in-part of U.S. application Ser. No. 10/988,714, filed on Nov. 15, 2004 by Kevin Gerard Donahue. The entire teachings of the above applications are incorporated herein by reference.

### BACKGROUND

Drawing and writing tablets and boards have existed for generations. Examples include chalk boards, white boards, mechanically-aided drawing devices, clipboards with side or back illumination, magnetic drawing tablets, fluorescent ink pens, luminescent tablets, phosphorescent tablets, thermochromic tablets, and pressure-sensitive tablets using plastic film and wax.

One example of an illuminable device is provided by U.S. Pat. No. 2,663,095 to Chase, which discusses a magic slate device. The magic slate device employs a light-diffusing film and an underlying opaque waxy material to produce an erasable drawing device. The magic slate device produces a marking when pressure is applied to the surface of its drawing film. This pressure causes the film to bond with the underlying opaque and waxy substrate. This bond enables ambient light to pass through the film and be absorbed by the underlying waxy material. The result is a visible marking. Separation of the film from the waxy material erases the marking.

The principle of extracting light from a light guide to produce an illuminated marking has been demonstrated in illuminated displays that use a crayon or maker to dispense an illuminable material upon the surface of an edge-illuminated light guide. These devices are often used in restaurants and other places where an illuminable display assists in the presentation of information.

### SUMMARY

In accordance with a particular embodiments of the invention, an illuminable marking device can overcome certain limitations in prior art marking devices by: (1) providing bright light-emitting drawings, writings, and tracing; (2) providing easy-to-read drawings and writings in single or multiple colors; (3) using a stylus or equivalent pressure-applying device as the marking instrument; (4) being erasable or permanent; (5) being easy to operate; (6) allowing for easy insertion of background colors and designs; (7) being usable under day or night lighting conditions; (8) being multipurpose (e.g. toy, bulletin board or white board, used in the dark, under water, in harsh environments); (9) being thin and lightweight in construction; and (10) being inexpensive to manufacture.

It is understood that when light attempts to exit a denser medium (higher index of refraction) to a less dense medium (lower index of refraction), such as when light travels through a clear glass or acrylic panel surrounded by air, light rays will not escape the denser medium if they contact the interface of the two mediums at an incident angle (as measured against the normal of the interface) that is greater than the critical angle associated with the two mediums. This means that light rays that are incident at angles greater than their critical angle are “internally reflected” within the denser medium, thus remain trapped. For example, the critical angle of an acrylic panel surrounded by air is about 42 degrees, so that when the angle of incidence of any light ray within the acrylic exceeds 42 degrees, that light ray will be reflected internally, thus remaining inside the acrylic panel. This phenomenon is called Total Internal Reflection (TIR). In accordance with particular embodiments of the invention, a light guide can promote internal reflection of light to increase the availability of light for eventual display.

A particular embodiment of the invention is an illuminable marking device operable in an ambient medium having an ambient index of refraction and its method of fabrication. The device can include a light guide panel, a light source, and an illuminable film.

The light guide panel can comprise a first optical material having an upper surface and a lower surface. The first material has a first index of refraction greater than the ambient index of refraction.

The light source can be optically coupled to the light guide panel for injecting light into the light guide panel. The injected light has an angle of incidence at the upper surface and lower surface of the light guide panel sufficient to establish total internal reflection.

The illuminable film can comprise a second optical material disposed over the upper surface of the light guide panel. The second material has a second index of refraction equal to or greater than the first index of refraction. The illuminable film can adhere to selected points on the upper surface of the light guide panel in response to localized pressure at the selected points. By adhering the illuminable film to the light guide panel, the illuminable film can be optically coupled with the light guide panel to extract injected light from the light guide panel to illuminate the illuminable film at the selected points.

In particular, the illuminable film can include a top layer and a bottom layer. The bottom layer can further include an illuminable adhesive comprising a second material that can adhere to the first material. The bottom layer can further includes a light-diffusing agent. More particularly, the illuminable adhesive can be arranged in a halftone pattern. In addition, the top layer can be a film substrate including a third material having a third index of refraction equal to or greater than the second index of refraction. The illuminable film can also include a colorant.

Furthermore, the light source can be optically coupled to edge-illuminate the light guide panel. In addition, the light source can include a plurality of colored light elements, such as LEDs, which can be selectively illuminated by a user.

The device can further include a mechanism for optically decoupling the illuminable film from the light guide panel. More particularly, the mechanism can mechanically separate the adhered illumination film from the upper surface of the light guide.

Another particular embodiment of an illuminable marking device operable in an ambient medium having an ambient index of refraction includes a light guide panel, a light source, and a multi-layered illuminable film.

The light guide panel can include a first optical material having an upper surface and a lower surface. The first material has a first index of refraction greater than the ambient index of refraction.

The light source can be optically coupled to the light guide panel for injecting light into the light guide panel. The injected light has an angle of incidence at the upper surface and lower surface of the light guide panel sufficient to establish total internal reflection.

The illuminable film can be disposed over the upper surface of the light guide panel. The illuminable film can include a bottom layer and a top layer.

The bottom layer can include an illuminable adhesive, which has a second index of refraction equal to or greater than the first index of refraction. The illuminable adhesive can be adhered to selected points on the upper surface of the light guide panel in response to localized pressure at the selected points. By adhering the illuminable adhesive to the light guide panel can optically couple the illuminable adhesive with the light guide panel to extract injected light from the light guide panel.

The top layer can include a second optical material disposed over the bottom layer. The second optical material has a third index of refraction equal to or greater than the second index of refraction so as to transmit extracted injected light from the illuminable adhesive to illuminate the second optical material at the selected points.

In particular, the illuminable adhesive can include a light-diffusing agent, such as titanium dioxide. In addition, the illuminable adhesive can be arranged in a halftone pattern on the top layer.

More particularly, the first optical material and the illuminable adhesive can include an acrylic material. The second optical material can be a plastic film, where the plastic can further include polyester, acetate, acrylic, or polycarbonate.

The light source can be optically coupled to edge-illuminate the light guide panel. The light source can further include a plurality of colored light elements, such as LEDs, which can be selectively illuminated.

The device can further include a mechanism for optically decoupling the illuminable film from the light guide panel. More particularly, the mechanism can mechanically separate the adhered illumination film from the upper surface of the light guide.

Another particular embodiment of an illuminable marking device operable in an ambient medium having an ambient index of refraction includes a light guide panel, a light source, a multi-layered illuminable film, and an erase mechanism.

The light guide panel can include a first optical material having an upper surface and a lower surface. The first material has a first index of refraction greater than the ambient index of refraction.

The light source can be optically coupled to the light guide panel for edge-illuminating the light guide panel with injected light. The injected light has an angle of incidence at the upper surface and lower surface of the light guide panel sufficient to establish total internal reflection.

The illuminable film can be disposed over the upper surface of the light guide panel. The illuminable film can include a bottom layer and a top layer.

The bottom layer includes an illuminable adhesive arranged in a halftone pattern of pixels. The illuminable adhesive can include a light-diffusing agent and has a second index of refraction equal to or greater than the first index of refraction. The illuminable adhesive pixels can adhere to selected points on the upper surface of the light guide panel in response to localized pressure at the selected points. By adhering the illuminable adhesive pixels to the light guide panel, the illuminable adhesive pixels can optically couple with the light guide panel to extract injected light from the light guide panel.

The top layer can include a second optical material disposed over the bottom layer. The second optical material has a third index of refraction equal to or greater than the second index of refraction to transmit extracted injected light from the illuminable adhesive pixels to illuminate the second optical material at the selected points.

The erase mechanism can optically decouple the adhesive pixels from the light guide panel. In particular, the mechanism mechanically separates the adhered illuminable adhesive pixels from the upper surface of the light guide.

In particular, the light-diffusing agent can include as titanium dioxide. More particularly, the first optical material and the illuminable adhesive can include an acrylic material. The second optical material can be a plastic film, where the plastic can further include polyester, acetate, acrylic, or polycarbonate.

The light source can further include a plurality of colored light elements, such as LEDs, which can be selectively illuminated.

Another particular embodiment of the invention includes an illuminable film for extracting light from an active light guide panel having a first index of refraction. The illuminable film can include a bottom layer and a top layer.

The bottom layer can include an illuminable adhesive, which has a second index of refraction equal to or greater than the first index of refraction. The illuminable adhesive can be adhered to selected points on the upper surface of the light guide panel in response to localized pressure at the selected points. By adhering the illuminable adhesive to the light guide panel can optically couple the illuminable adhesive with the light guide panel to extract injected light from the light guide panel.

The top layer can include a second optical material disposed over the bottom layer. The second optical material has a third index of refraction equal to or greater than the second index of refraction so as to transmit extracted injected light from the illuminable adhesive to illuminate the second optical material at the selected points.

In particular, the illuminable adhesive can include a light-diffusing agent, such as titanium dioxide. In addition, the illuminable adhesive can be arranged in a halftone pattern on the top layer.

More particularly, the illuminable adhesive can include an acrylic material. The second optical material can be a plastic film, where the plastic can further include polyester, acetate, acrylic, or polycarbonate.

The illuminable film can also include a layer of a magnetic material disposed between the bottom layer and the top layer. The magnetic material can be disposed in a halftone pattern on the top layer.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of a particular illuminable marking device employing an illuminable pressure-sensitive film in accordance with the invention.

FIG. 2 is foreshortened schematic cross section of the device taken along line A-A of FIG. 1.

FIG. 3 is a schematic cross section of a two-sided light guide panel 30′ for use in a two-sided pressure-sensitive drawing tablet.

FIG. 4 is a foreshortened schematic cross section of a particular embodiment of the operation of a light guide panel and illuminable film of FIG. 2.

FIG. 5 is a foreshortened schematic cross section of a multi-layered illuminable film.

FIG. 6 is a foreshortened schematic cross section of a particular embodiment of a composite light guide in accordance with the invention.

FIG. 7 is a foreshortened schematic cross section of another embodiment of a composite light guide.

FIG. 8 is a foreshortened schematic cross section of another composite light guide in accordance with the invention.

FIG. 9 is a foreshortened schematic cross section of a particular embodiment of an optical marking sheet.

FIG. 10 is a foreshortened schematic cross section of another embodiment of an optical marking sheet.

FIG. 11 is a foreshortened schematic cross section of another embodiment of an optical marking sheet.

FIG. 12 is a perspective front view of a particular toy embodiment of an illuminable marking device.

FIG. 13 is an exploded view of the toy device of FIG. 12.

FIG. 14 is a schematic top view of a particular illuminable pressure-sensitive film employing a pattern of adhesive pixels.

FIG. 15 is a foreshortened schematic cross section of the illuminable film of FIG. 14 in operation.

FIG. 16 is a schematic perspective view of a magnetic erasable film.

### DETAILED DESCRIPTION

In accordance with a particular embodiment of the invention, an illuminable marking device can overcome certain limitations of the prior art by: (1) providing bright light-emitting drawings, writings, and tracing; (2) providing easy-to-read drawings and writings in single or multiple colors; (3) using a stylus or equivalent pressure-applying device as the marking instrument; (4) being erasable or permanent; (5) being easy to operate; (6) allowing for easy insertion of background colors and designs; (7) being usable under day or night lighting conditions; (8) being multipurpose (e.g. toy, bulletin board or white board, used in the dark, under water, in harsh environments); (9) being thin and lightweight in construction; and (10) being inexpensive to manufacture.

From Snell's Law, it is understood that when light attempts to exit a denser medium (higher index of refraction) to a less dense medium (lower index of refraction), such as when light travels through a clear glass or acrylic panel surrounded by air, light rays will not escape the denser medium if they contact the interface of the two mediums at an incident angle (as measured against the normal of the interface) that is greater than the critical angle associated with the two mediums. This means light rays that are incident at angles greater than their critical angle are “internally reflected” within the denser medium, thus remain trapped. This phenomenon is called Total Internal Reflection (TIR).

The critical angle is the minimal incident angle for preventing light loss from the denser medium. Critical angles are determined by the respective compositions of two adjoined mediums as represented by their indices of refraction. For example, the critical angle of an acrylic panel surrounded by air is about 42 degrees. This means when the angle of incidence of any light ray within the acrylic exceeds 42 degrees, that light ray will be reflected internally, thus remaining inside the acrylic panel. In accordance with embodiments of the invention, a light guide can promote internal reflection of light to increase the availability of light for eventual display.

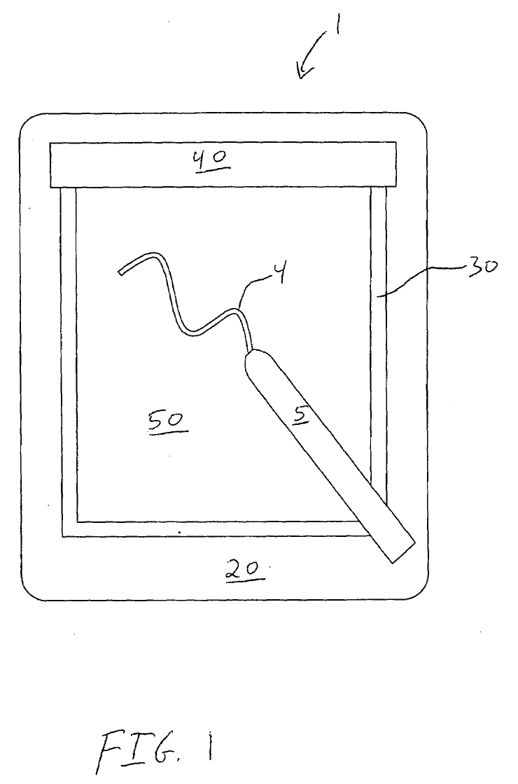

FIG. 1 is a schematic of a particular illuminable marking device employing an illuminable pressure-sensitive film in accordance with the invention. As shown, the device 1 includes a backing structure 20, a light guide panel 30, a light source 40, and an illuminable film 50. As shown, an illuminated mark 4 being made by pressing a marking instrument 5, such as a stylus, against the illuminable film. Although shown as a blunt-tipped stylus, the marking instrument 5 can be any other suitable pressure-applying device, including a finger, a stamp or a print head, such as a dot matrix print head. In a particular embodiment, the device is a toy for use by children.

The light guide panel 30 is a light-transmitting plate that channels propagated light using the principles of total internal reflection (TIR). In addition to materials such as glass, acrylic, and polycarbonate, the light guide panel 30 can include a liquid or a gel.

The backing structure 20 is positioned below, but not bonded to, the light guide panel 30. In particular, there is an air gap between the backing structure 20 and the light guide panel 30. In a particular embodiment, the backing structure is cardboard, but can be a sheet of any other suitably rigid material, such as plastic.

The light source 40 is optically coupled to the light guide panel 30. The light source 40 injects light into the light guide panel 30 at an angle of incidence greater than the critical angle needed to initiate TIR. This can be accomplished by edge-illuminating the light guide panel 30 using a plurality of LEDs. In particular, the light source 40 is fabricated from a light weight material such as plastic.

The illuminable film 50 is a pressure-sensitive light-extracting film that can be removably adhered to the light guide panel 30. The light guide panel 30 illuminates the illuminable film 50 through bonds between the light guide panel 30 and the illuminable film 50 created by pressure from the marking instrument 5. It is emphasized that unless light is extracted from the light guide panel 30, a user cannot see the light trapped within the light guide panel 30.

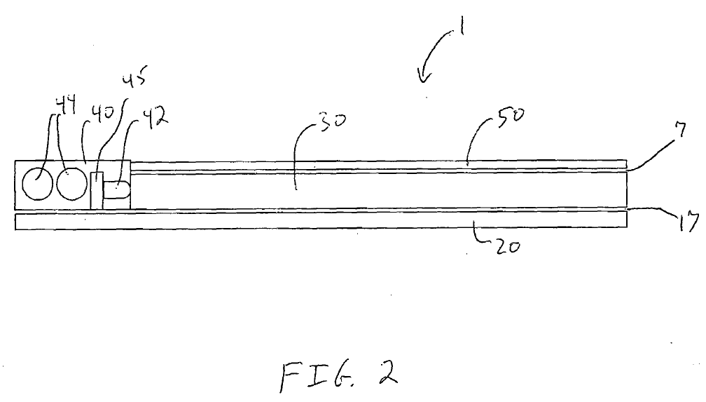

FIG. 2 is foreshortened schematic cross section of the device taken along line A-A of FIG. 1. As shown, the light guide panel 30 is disposed over the cardboard backing structure 20, separated by a slot 17 for receiving an illustrated drawing sheet. The light guide panel 30 has an upper surface 32 and a lower surface 34, both of which are formed to maintain light within the light guide panel 30. The illuminable film 50 is also shown with its upper surface 52 and lower surface 58 identified.

The light guide panel 30 can be fabricated from a hard, solid or semi solid, optical (light transmitting) material. The upper surface 32 and lower surface 38 of the light guide panel 30 is smooth to maintain TIR with the light guide panel 30.

A thin layer of air 7 normally separates the light guide panel 30 from the illuminable film 50. Light can travel within the light guide panel 30 without emission due to the total internal reflection of the light injected by the light source 40. The layer 7 of air between the light guide panel 30 and the illuminable film 50 preserves the smooth upper surface 32 of the light guide panel 30 and thus maintains TIR. As described below, a bond between the light guide panel 30 and the illuminable film 50 breaks the smooth surface 32 of the light guide panel 30 and results in light being extracted from the light guide panel 30 and into the illuminable film 50.

The light source includes LEDs 42, which can generate white light or light of different colors (such as red, green, and blue). The LEDs 42 are powered by power source 44, such as batteries, and provides edgewise illumination into light guide panel 30. The brightness of the injected light can be varied by controlling the intensity of the light source, while the color can be changed by a color selector switch that selectively illuminates the RGB LEDs. A circuit module 45 is provided to apply such user inputs. The light guide panel 30 is designed using light ray modeling software for minimum light loss and uniform brightness for specific LEDs as light sources.

The upper, or receiving, surface 32 of the light guide panel 30 bonds with the lower, or positioning, surface 58 of the illuminable film 50 to provide light extraction from the light guide panel 30. A sticky optical (light transmitting) layer, such as paraffin or silicon, can be applied to the upper surface 32 of the light guide panel 30. Alternatively, the sticky optical layer can be applied to the lower surface 58 of the illuminable film 50.

The light guide panel 30 can be transparent, colored, or multi-colored. Coupling mechanisms with individual LEDs 42 are provided for edge illumination of the light guide panel 30. This can include a light guide rim that provides edge illumination to the light guide at all four edges to facilitate uniform light extraction. The composition, thickness, and pliability of the light guide panel 30 will vary depending on the intended application. It is particularly designed for low-cost manufacturing through plastic extrusion or injection molding.

When the light guide panel 30 and illuminable film 50 are substantially clear, a suitably rigid plate containing a background design for tracing may be placed between the light guide panel 30 and the backing structure 20. In a particular embodiment the rigid plate is a heavy-weight paper.

There are various embodiments of the illuminable film and the light guide. Some examples of each follow. One of ordinary skill in the art should recognize additional embodiments.

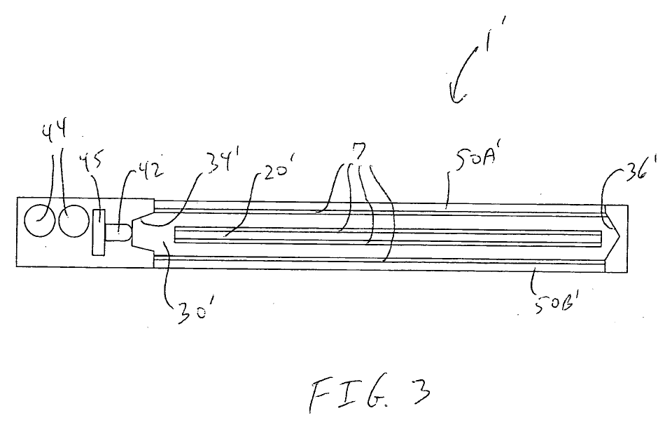

FIG. 3 is a schematic cross section of a two-sided light guide panel 30′ for use in a two-sided pressure-sensitive drawing tablet. Between an upper half 31′ and a lower half 39′ of the light guide panel 30′ is a cardboard backing structure 20′. Light from LEDs 42, powered by power source 44, is propagated between the two halves 31′, 39′ of the light guide panel 30′ through reflectors 34′, 36′ at the two ends. The two halves of the light guide panel 30′ are normally separated from the respective illuminable films 50A′, 50B′ by layers of air 7. A slot (not shown) can be provided on each side of the backing structure 20′ for insertion of a background design sheet. Such a two-sided drawing tablet is useful as an outdoor sign or where a drawing or writing needs to be displayed in opposite directions.

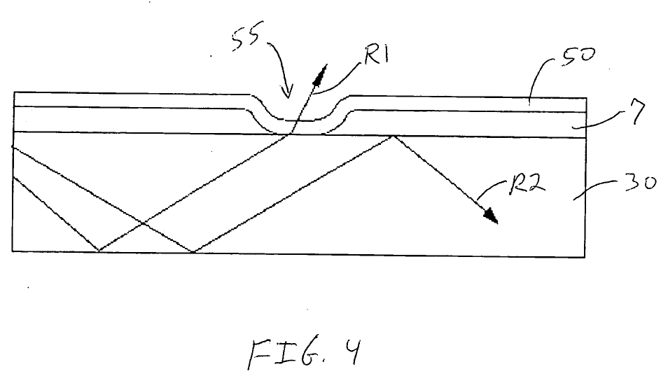

FIG. 4 is a foreshortened schematic cross section of a particular embodiment of the operation of a light guide panel and illuminable film of FIG. 2. As shown, light rays R1, R2 are propagating through the light guide panel 30 due to TIR. Light represented by ray RI is extracted from the light guide panel 30 into the illuminable film 50 through a light-extracting point 55. The light-extracting point 55 is formed when pressure from a stylus 5 (FIG. 1) or finger depresses the illuminable film 50 through the layer of air 7 to form a bond with the light guide panel 30. The bond maintains TIR within the light guide panel 30 without incurring Fresnel light loss. In this way, drawing on the tablet 1 with a stylus 5 has the effect of drawing lines of light.

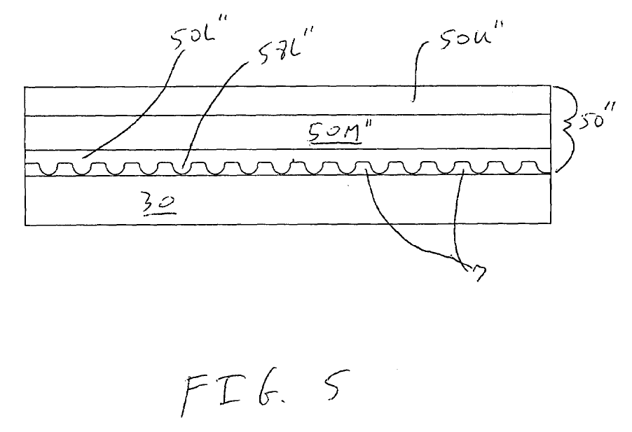

FIG. 5 is a foreshortened schematic cross section of a multi-layered illuminable film. As shown, the illuminable film 50″ has three layers. An upper layer 50U″ of the film 50″ is designed to promote light emission through a diffusing surface. A light-transmitting middle layer 50M″ transmits and/or transforms and/or manipulates the extracted light. A lower layer 50L″ is designed to maintain the layer of air 7 between the light guide panel 30 and the illuminable film 50″ so as to preserve TIR within the light guide panel 30. The lower layer 50L″ adheres to the light guide panel 30 upon application of pressure and extracts light from the light guide panel 30 at extraction points 55L″ as described above in FIG. 4.

To maintain a layer of air 7 between the illuminable film 50″ and the light guide panel 30, and to facilitate bonding between the illuminable film 50″ and the light guide panel 30 when pressure is applied from a stylus 5, the lower layer 50L″ can have micro-bumps 58L″ or any other protruding or textured structure that maintains a layer of air 7 between the film 50″ and the light guide panel 30. The lower layer 50L″ can have a contact layer (in a multi-layer film) comprising an adhesive optical (light transmitting) material such as pliable plastics, including low-density polyethylene or any other material that can establish a temporary optical adhesion to the light guide, including a paraffin or silicon compound.

In addition to micro-bumps 58L″, the lower layer 50L″ can also have light-extracting micro-dots to form the bonds between the illuminable film 50″ and the light guide panel 30 when pressure is applied from a stylus 5. The micro-dots can be any protruding structure, in any arrangement, capable of extracting light from a light guide panel 30. That is, the only bonds formed between the illuminable film 50″ and the light guide panel 30 are the bonds formed between the light-extracting micro-dots and the light guide panel 30. This allows light within the light guide panel 30 to propagate past a line of light-extracting micro-dot bonds, thereby providing sufficient light to other areas within the light guide panel 30 where light can be extracted through other micro-dot dot bonds formed in that area. Visually, the line of light created when pressure is applied from a stylus 5 is a “halftone” line, or a line of dots of light.

Returning to FIG. 2, drawings on the illuminable films 50 can be erased by breaking the bonds between the film 50 and the light guide panel 30. There are many ways to mechanically break the bonds between the illuminable film 50 and the light guide panel 30 such as by peeling back the illuminable film 50 from the light guide panel 30 by hand or through the use of a hinge mechanism, by a spring-loaded mechanism, by an air knife to lift the illuminable film 50, by a slider having a lifting blade under the illuminable film 50, and so forth. Alternatively, the drawing on the illuminable film 50 can be made permanent when a permanent or difficult-to-break bond is established between the illuminable film 50 and the light guide panel 30.

To minimize line distortion when pressure is applied, the illuminable film 50 can include a hard plastic upper layer, such as polyester, plus one or more sub-layers to establish and maintain an optical adhesion to the light guide panel 30. The illuminable film 50 can also include a protective marking surface. The illuminable film 50 can also include an integrated light guide via a permanent bonding between the film 50 and the light guide panel 30. The light-extracting film 50 is designed for low-cost manufacturing through plastic extrusion, injection molding, or cast-film process.

Another embodiment of the invention can employ photoreactive compounds. The device can include an illuminable film 50″ with a middle layer 50M″ comprising one or more fluorescent, luminescent, phosphorescent, or photochromic compound. A distinct color and/or luminescence will then appear when the illuminable film 50″ is exposed to extracted light of an activating wavelength, e.g. ultraviolet light. An optical bandpass filter (not shown) can be disposed on the middle layer of film 50M″ to block light of an activating wavelength, such as filtering ultraviolet light to prevent photochromic activation from exposure to sunlight.

Color change or luminescence in the photoreactive illuminable film 50″ will be sustained as long as exposure to light of activating wavelength is maintained through temporary or permanent adhesion to the light guide panel 30. Adding a source of visible light to an existing light of activating wavelength will intensify and/or change the color of the resultant emitted light. Erasure is accomplished by breaking the bond between the light guide panel 30 and the illuminable film 50, such as by peeling away the film from the light guide panel 30 or by other means. Erasure of drawings or writings on a fluorescent or photochromic film can also be accomplished by turning off the LED light source. For certain phosphorescent and photochromic films, using LEDs of deactivating wavelengths will also erase the drawing or writing on the film.

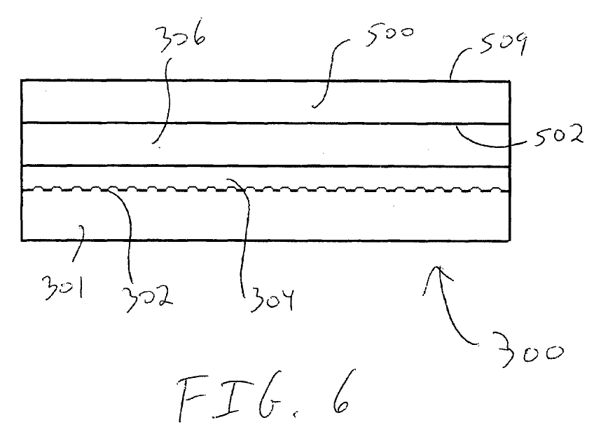

FIG. 6 is a foreshortened schematic cross section of a particular embodiment of a composite light guide in accordance with the invention. The composite light guide panel 300 includes a light guide panel 301 with a diffusing upper surface 302 above which is disposed a layer of gel 304 with an index of refraction sufficient to maintain TIR within the combined light guide panel 300 and layer of gel 302. A layer of a compressible material 304 (such as air) with an index of refraction sufficient to maintain TIR within the combined light guide panel 300 and layer of gel 302 as a single layer, is disposed above layer of gel 302, and below a light-extracting film 500.

When there is no pressure on light-extracting film 500, TIR is maintained within the combined light guide panel 300 and layer of gel 302 as a single layer. When pressure is applied to the upper surface 509 of the light-extracting film 500, a bond is formed between the lower surface 302 of light-extracting film 500 and the diffusing upper surface 302 of light guide panel 300. The diffusing upper surface 302 enhances light extraction from the light guide panel 300.

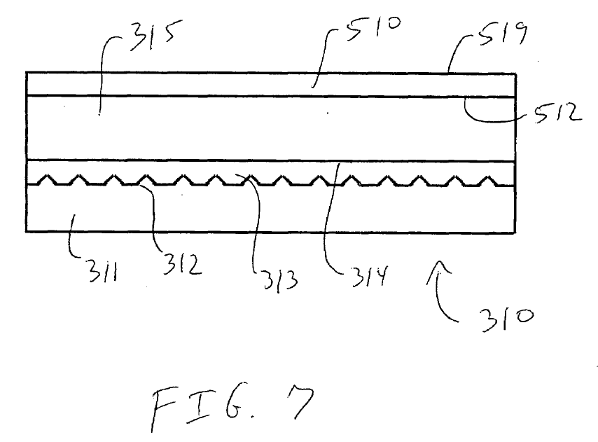

FIG. 7 is a foreshortened schematic cross section of another embodiment of a composite light guide. The composite light guide 310 includes a reflecting layer 311 with a surface of reflector ridges 312. A layer of a compressible material 313 (such as air) with a low index of refraction sufficient to maintain TIR within a light guide panel 315 is disposed between reflecting the layer 311 and the light guide panel 315.

Disposed on the light guide panel 315 is a light-extracting film 510 with its lower surface 512 in contact with the light guide panel 315. The light-extracting film 510 is fabricated from a material with an index of refraction sufficient to maintain TIR within light guide panel 315.

The light guide panel 315 is made of a moldable optical material. Under pressure the light guide panel 315 conforms to the shape of reflector ridges 312 facing the light guide panel 315. That is, applying pressure on the light guide panel 315 will create reflector shapes on the bottom surface 314 of the light guide panel 315 facing reflector ridges 312, thereby reflecting light upward through the light guide panel 315.

It should be noted that the composite light guide 310 can operate without the light extracting film 510. However, it may be desirable to include a protective marking surface over the light guide panel 315.

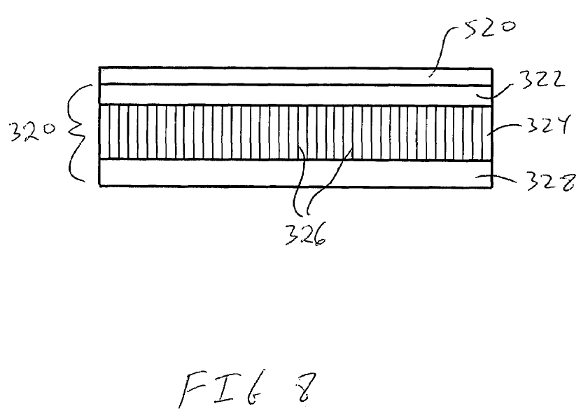

FIG. 8 is a foreshortened schematic cross section of another composite light guide in accordance with the invention. In this embodiment, an elastic light-extracting film 520 is disposed on a composite light guide 320 comprising an elastic layer 322, a layer of gel 324 with an index of refraction sufficient to maintain TIR within the composite light guide 320, and a layer of thin flexible film 328. Disposed within the layer of gel 324 is a honeycombed grid or mesh of vertical support pins 326 that crumple when pressure is applied to elastic layer 322 of the composite light guide 320. The vertical support pins 56 can be any device or structure capable of being compressed or crumpled. However, the honeycomb structure and the gel should have the same index of refraction so light rays can transverse the structure while maintaining TIR.

In operation, pressure is applied with a stylus or other means to the elastic light-extracting film 520. In response, the light guide layer 322 and vertical support pins 326 crumple beneath the area where the stylus applies pressure. When the stylus is lifted, the elastic light-extracting film 520 and the light guide layer 322 substantially rebound to their original un-compressed shape. This causes the flexible film 328 to form a crimp or light reflective angle, thereby reflecting light upward through the light guide 320.

It should be noted that the composite light guide 320 can operate without the light extracting film 520. However, it may be desirable to include a protective marking surface over the light guide 320.

Another embodiment of the invention includes an optical marking sheet. An optical marking sheet is a relatively thin marking or writing medium made with a light guide or a backlight. Because light guides and backlights can be as thin as several millimeters or less, such a marking sheet, in appearance and use, can be similar to a piece of paper.

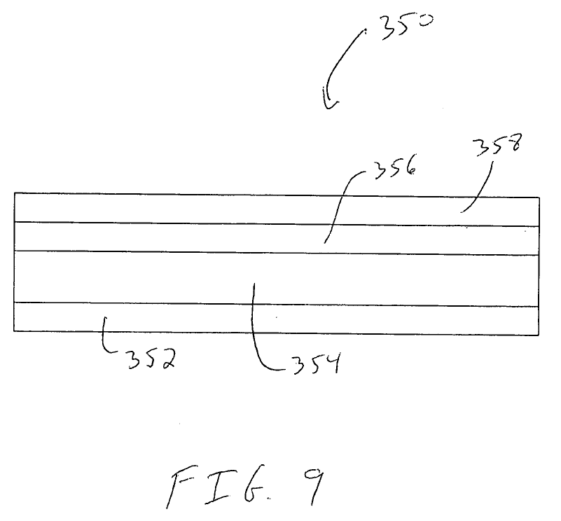

FIG. 9 is a foreshortened schematic cross section of a particular embodiment of an optical marking sheet. This optical marking sheet 350 can be constructed to be very thin and flexible, or can be constructed as a rigid sheet composed of a light guide 354 integrated with a light-extracting film 358. A cardboard backing 352, or other rigid material, may be used to support the optical marking sheet 350. TIR is maintained within the light guide 354 by inflating or trapping air 356 between the light guide 354 and the light-extracting film 358. The optical marking sheet 350 can be colored, and may contain fluorescent, luminescent, phosphorescent, or photochromic compounds. Special tablets are designed to hold sheets of optical marking sheet, or a roll of optical marking sheet, and to provide a coupling mechanism with LEDs for edge illumination. When the optical marking sheet 350 is substantially clear, a rigid plate containing a background design for tracing can be placed behind the light guide medium 350, or between sheets in a tablet. The optical marking sheet 350 can also include a protective marking surface. The sheets are designed for low-cost manufacturing through plastic extrusion or cast-film process.

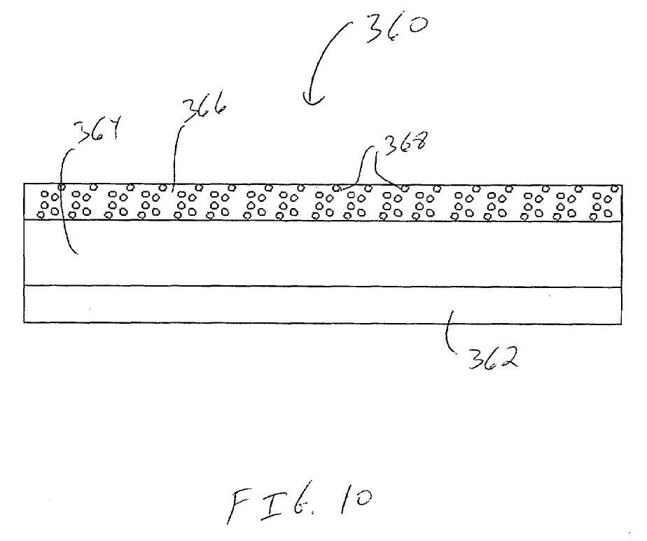

FIG. 10 is a foreshortened schematic cross section of another embodiment of an optical marking sheet. In this embodiment, a backlight 364 and a companion light-blocking film 366 are substituted in place of the light guide and companion light-extracting film of FIG. 9. The backlight 364 is a light guide with a diffusing upper surface to promote light emission. The backlight 364 is generally illuminated by LEDs or Cold Cathode Fluorescent Lamps. As shown, the backlight 364 is structurally supported by a cardboard backing 362. The light-blocking film 366 is disposed on the backlight 364.

When pressure is applied and the light-blocking film 366 is compressed, light is transmitted from the backlight 364 due to a change in the film 366 from opaque or semi-opaque to transparent or semi-transparent. Thus adhesion is not required to transmit light, and a backlight 364 is used instead of a true light guide. The non-adhesive pressure-sensitive light-blocking film 366 can be colored, and can include fluorescent, luminescent, phosphorescent, or photochromic compounds.

In the particular example of FIG. 10, the light-blocking film 366 has air bubbles 368 dispersed throughout. Applying pressure on the film 366 with a stylus 5 will break the air bubbles 368 and allow light to be transmitted from the backlight 364 through the film 366.

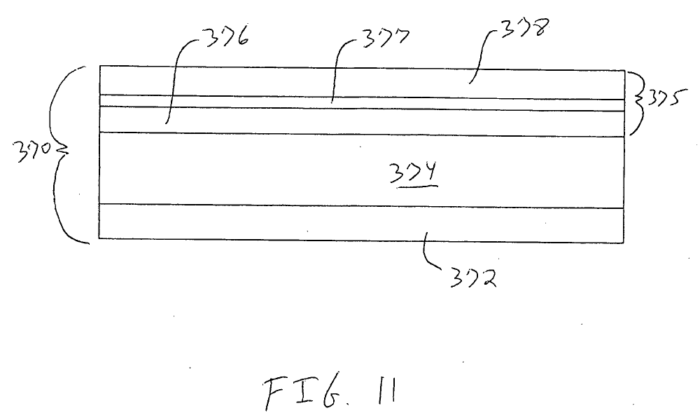

FIG. 11 is a foreshortened schematic cross section of another embodiment of an optical marking sheet. As shown, the optical marking sheet 370 includes a backlight 374 supported by a cardboard backing 372 similar to that described above in FIG. 10. A particular light-blocking film 375, however, comprises two layers of film 376, 378, with a layer of opaque gel 377 disposed between the two layers. Applying pressure on the upper film 378 with a stylus will disperse or move the opaque gel 377 and allow light to be transmitted from the backlight 374 through the light blocking film 375.

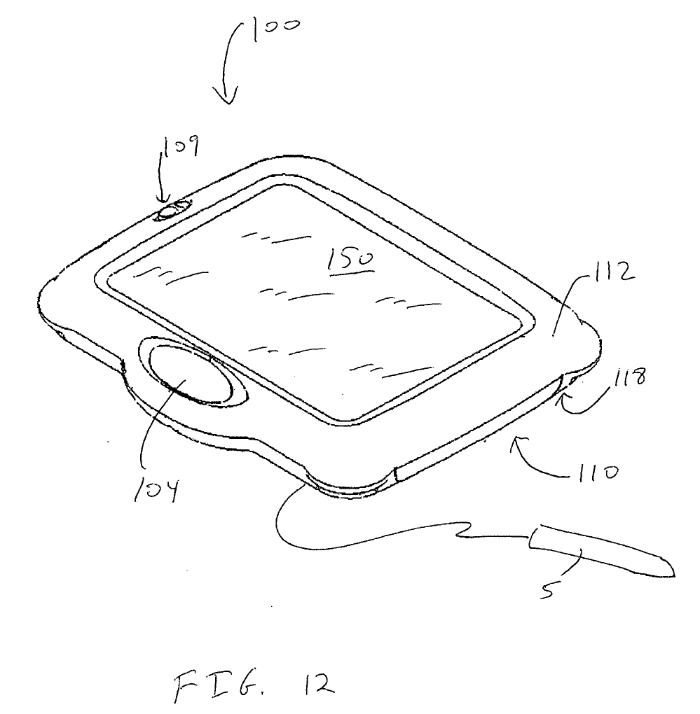

FIG. 12 is a perspective front view of a particular toy embodiment of an illuminable marking device. A particular embodiment of the drawing and tracing device is a toy embodiment, which enables children to draw and trace with light.

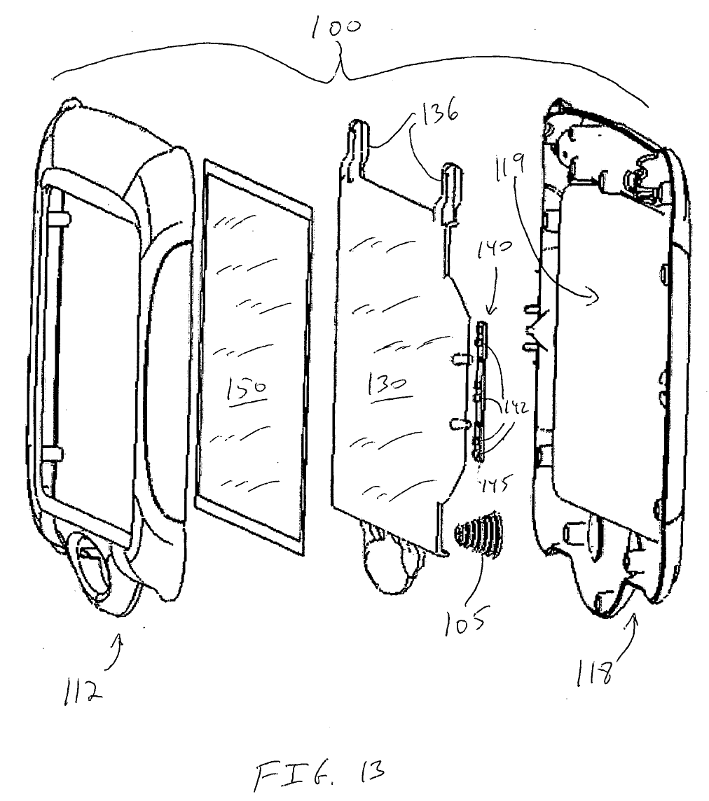

The toy 100 has a supporting housing 110 with a top lid 112 and a bottom base 118. The top lid 112 houses an illuminable pressure-sensitive film 150, an erase button 104 that facilitates erasure by depressing the light guide panel 130 (FIG. 13), as will be described below. A sliding control switch 109 allows the user to select the color of the illumination. In addition, a stylus 5 is shown tethered to the housing 100. While not shown, the toy 100 can be provided with stencil stamps that can be used to create drawings of different shapes to complement drawings made with the stylus 5.

FIG. 13 is an exploded view of the toy device of FIG. 12. The toy 100 includes the lid section 112 and the base section 118. The illuminable pressure-sensitive film 150 is secured to the lid 112 with and adhesive or double-faced tape. As shown, the light guide panel 130 includes the erase button 104 on one end and is pivotably attached to the base 118 at hinges 136 on the other end.

While a rectangular or other regular shaped light guide could be mounted to a frame, the number of parts can be reduced by integrating the erase button 104 and the hinges 136 into the light guide panel 130 itself. The illustrated shape was modeled to produce minimal light loss. The hinges 136 are also positioned to extract minimal light.

The light guide panel 30 is edge-illuminated by a light injection module 140, which operates one or more LEDs 142 under the control of circuitry 145. In addition to changing the color of the light, and thus the illuminated drawing, a power control device can cause the LEDs to blink randomly or at prescribed time intervals.

A spring 105 upwardly biases the light guide panel 130 against the illuminable film 150 so they maintain contact to facilitate drawing. The spring bias is released by depressing the erase button 104, which compresses the spring 105 and allows the weight of the light guide panel 130 to mechanically separate the light guide panel 130 from the illuminable film 150. That separation action removes any present illumination.

The base 118 has a clear flat bottom 119 to facilitate tracing of a background illustration placed underneath the clear bottom 109. Such an illustration is viewable through the light guide panel 130 and the illuminable film 150. The background illustration can include alphabets and numerals for children to trace. Other designs can include drawings of popular toy figures, book characters, and heroes from comic books, cartoons, and movies.

Protective films can be added to the exposed surfaces of the illuminable film 130 and the light guide panel 130 to inhibit scratches and finger prints.

In a particular embodiment, a drawing and tracing device 100 can generate an illuminated image when the pressure-sensitive light-extracting film 150 bonds to its underlying light guide panel 130. More particularly, an adhesive pixel extracts light from an underlying light guide.

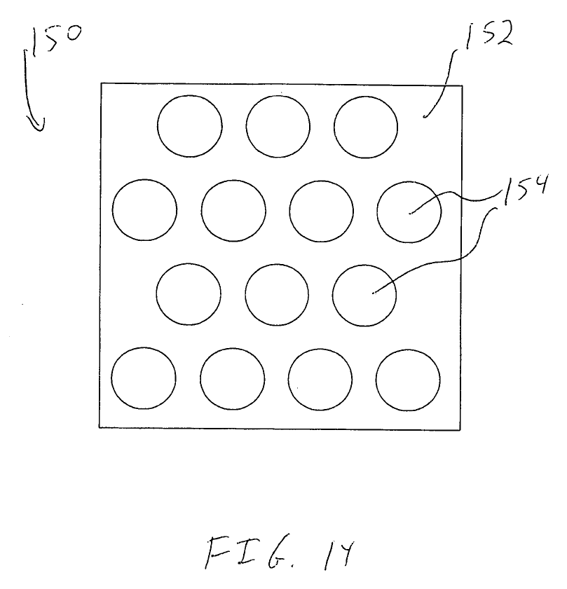

FIG. 14 is a schematic top view of a particular illuminable pressure-sensitive film employing a pattern of adhesive pixels. The illuminable pressure-sensitive film 150 includes a clear plastic sheet 152, such as polyester, that is covered with a uniform layer of pixels 154 made from a light-extracting adhesive that is capable of adhering to an underlying light guide panel 130 (FIG. 13) of a given composition. In a particular embodiment, this adhesive is acrylic-based and provides adhesion that can sustain an illuminated image for several minutes, yet this image can still be removed through mechanical separation, i.e., peeling or other means. This adhesive can also includes a light-diffusing pigment to promote the display of any extracted light.

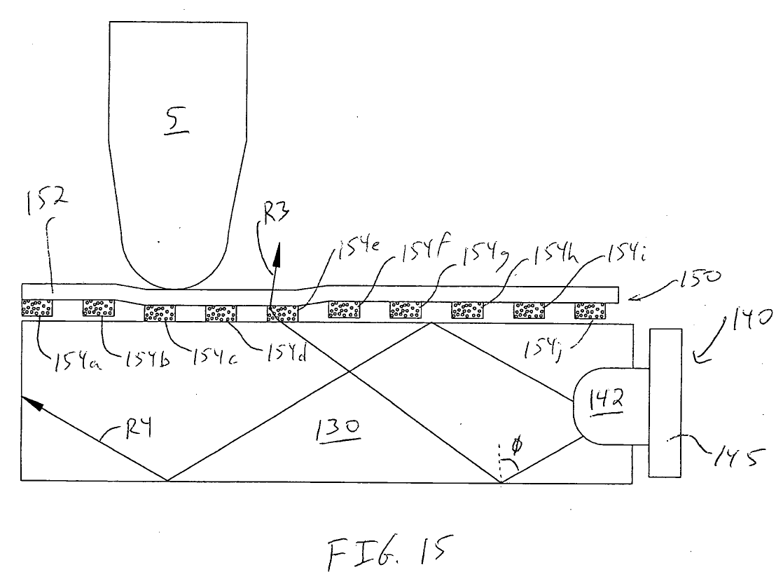

FIG. 15 is a foreshortened schematic cross section of the illuminable film of FIG. 14 in operation. The light guide 130 is edge illuminated by an illumination module 140 containing one or more LEDs 142. As shown, light rays, represented by rays R1, R2, are injected into the light guide panel 130 by an LED 142 of the edge-illumination light source 140. The plastic light guide panel 130 is surrounded by air, which provides a critical angle of incidence within the light guide 130 for light to be experience total internal reflection. The light rays R3, R4 have are provided with an angle of incidence φ that is great than the critical angle of incidence, which causes the light rays R3, R4 to experience total internal reflection.

The illuminable pressure-sensitive film 150 is shown on top of the light guide, but a sufficient air gap remains to maintain TIR within the light guide 130. The illuminable pressure-sensitive film includes is a clear polyester film 152, the bottom surface of which is patterned with light-extracting pixels 154. The light-extracting pixels 154 comprise a repositionable pressure-sensitive adhesive that has an index of refraction equivalent or greater than the index of refraction of the edge-illuminated light guide panel 130 to enable light extraction. The pressure sensitive adhesive also includes a diffusing agent to produce sufficient light refraction to cause pixel illumination. In a particular embodiment, the pixels 154 are arranged in a halftone pattern of dots that cover 30% of the surface of the polyester film 152 at a resolution of approximately 70 lines per inch.

An illuminated marking is created when pressure is applied by the stylus 5 or some other device to the surface of the illuminable pressure-sensitive film 150. This pressure causes the polyester film 152 to deflect causing one or more underlying pixels 154c, 154d, 154e to adhere to the edge-illuminated light guide 130. Light rays, as represented by ray R3, that intersect any pixel 154c, 154d, 154e that is adhered to the light guide panel 130 enter the pixel where they are then diffused by a diffusing material, such as a pigment, to produce illumination.

In the film 150, the adhesive pixels 154 are printed in a halftone pattern of sufficient index of refraction to produce a visible image without causing unwanted adhesion or spontaneous image erasure. Unwanted adhesion can occur when an inactive (non-illuminated) pixel adjacent to an active (i.e., illuminated) pixel becomes activated by the adhesive pressure being exerted by a neighboring active pixel. That effect can causes illuminated lines to widen over time. One particular method to inhibit unwanted adhesion is balance the weight of the polyester sheet 152 against the thickness of the adhesive pixels 154. For example, a particular film 150 has a 3-5 mil (0.003-0.005″) polyester sheet and an adhesive pixel thickness not to exceed 0.00075″.

Unwanted image erasure can occur when air is trapped between the film 150 and its underlying light guide panel 130. Upon application of pressure to the surface of the film 150, the volume of space available for trapped air decreases thus increasing pressure. That pressure increase causes the bonds between the adhesive pixels and their underlying light guide panel 130 to break causing limited to severe image erasure. That problem can happen when the film 150 is 100% coated with a light extracting adhesive, or when the film 150 has a high density of adhesive pixels 154, such as when the half-tone pattern of adhesive pixels 154 comprises over 70% of the surface area of the polyester sheet 152. Further, the use of a light diffusing static cling film as a light extracting film 150 substitute can also produce unwanted erasure due to air-trapping. Printing the adhesive pixels 154 in a halftone pattern enables air to flow around each pixel so air displacement caused by the application of pressure to the film's 150 surface can escape without breaking a bond between a pixel 154 and its underlying light guide panel 130.

In a particular embodiment, the bottom (light guide adhering) surface of the adhesive pixel is flat and of consistent thickness. Strength of the adhesion of a pixel is dependent on the thickness, so consistent pixel thickness is desirable for a consistent illuminable pressure-sensitive film 150. The pixels 154 have a geometric shape similar to that of a hockey puck, ensures that the pixels 154 can make substantial contact with the underlying light guide panel 130 to produce illumination.

The pixels 154 possess sufficient adhesive strength to produce a bond with a light guide panel 130 when pressure is applied to the top surface of the substrate 152. The pixels 154 lack the adhesive strength to produce unwanted bonding. That is, when the illuminable pressure sensitive film 150 is placed on top of the light guide panel 130, there will be an air layer between the film 150 and the light guide panel 130 when no downward pressure is being applied to the film 150. Unwanted bonding occurs when the weight of the film substrate 152, which sits on top of the pixels 154, creates sufficient downward pressure to cause pixel adhesion to the light guide panel 130. This creates unwanted illumination. Accordingly, the weight of the film substrate (a plastic film, such as, polyester) and pixel thickness are counterbalanced to ensure proper operation of any illuminable pressure-sensitive film that is to be used in conjunction with the device.

To efficiently transmit light from the light guide panel 130 to the pixels 154, the pixel material and the light guide material have matching indices of refraction. Accordingly, a pixel 154 using an acrylic adhesive efficiently extracts light from an acrylic light guide panel 130 because they have the same index of refraction.

In accordance with a particular embodiment, the adhesive is printed on the plastic substrate 152 at the pixel locations 154. Together, the pixels 154 and the plastic substrate 152 comprise the illuminable pressure-sensitive film 150. Further details regarding particular materials and the procedure for producing the illuminable pressure-sensitive film 150 are described below.

The plastic substrate 152 is flexible so it can precisely transfer pressure to the pixels 154 to produce accurate illumination. A proven plastic material is Polyester that is “0.001” to “005” (1 to 5 mil) thick. The print-side of the polyester is treated to promote adhesion of the pixel adhesive with a clear primer that increases the surface energy of the polyester. Such “print-ready” polyester is commercially available from many polyester film providers.

The pixel adhesive is a non-permanent, pressure-sensitive adhesive that contains a light diffusing agent. The adhesive contains acrylic monomer to promote adhesion; a tackifier such as an oligomer to adjust tack and viscosity (to 7,000 centipoise or greater); a photo-initiator that causes the acrylic monomer to polymerize (cure) upon exposure to ultraviolet light; and titanium dioxide powder that acts as a light-diffusing agent. The particular illuminable adhesive includes a screen-printable permanent UV produced by Radcure of Wayne, N.J. under part number 15UVSPL.

Screen printing techniques are used to produce the illuminable pressure sensitive film 150. The screen component of the printing press uses a fine mesh screen of 330 Mesh (threads crossing per square inch) that is applied with high-tension (over 20 Newtons) to a screen frame. The screen frame is 300% larger than the size of the printing area (the area that prints the pixels) of the illuminable pressure-sensitive film 150. This large screen is used to generate uniform screen tension in the printing area of the screen. Uniform screen tension in the printing area of the screen helps to maintain uniform pixel thickness.

Once the screen is made, it is precisely coated with a photosensitive resist that has a thickness equivalent to the height of the desired pixel. This is achieved by applying a resist film of pre-set thickness or through precise spray coating. A qualified vendor for making such a screen is DEK of Weymouth, England.

To create the actual print-ready screen, a photo-positive halftone image is “burnt” into the resist. Prior to exposure, this halftone image is placed upon the screen so each pixel image on the halftone film receives an equivalent area of mesh opening. Also, the halftone image is aligned on the screen such that the screen mesh does not change the shape of any pixel, thereby producing an undesirable Moiré Effect.

The screen printing press for production uses a print head that floods and prints at a constant rate to avoid inconsistent adhesive deposits that cause variability in pixel thickness. The screen printing press uses a hydraulic-based print head to ensure a constant print rate; a servo-based print head is an acceptable alternative. Further, the print head has a squeegee angle 30 degrees and a vacuum table to hold the plastic film in place during the printing process. Holes in the vacuum table are less than 1/32″ in diameter and set apart ¼″ in a grid pattern to prevent dimpling of the plastic film during the printing process.

To cure the printed adhesive, the printed film is placed on a vacuum table and then exposed to high-intensity UV light. To cure the adhesive in less than 10 seconds, a 300-400 watt per inch lamp with a length equal to or greater the width of the printed area on the illuminable film is employed. The lamp is doped with iron to ensure the UV curing light can penetrate the surface of the adhesive. The illuminable film is cured on a sliding vacuum table so that it does not wrinkle during curing. Further, this vacuum table is equipped with an internal heat sink and cooling fins to prevent the vacuum table from overheating.

Following printing and curing, the structure is pinched by Nip Rollers at 80 pounds pressure or greater to improve the flatness of the pixels. Note that after curing, the pixel shape is fixed. The pinching operation, however, compresses any extraneous deposits on the surface of the pixels back into their respective pixels.

The entire film printing operation is particularly conducted in a Class 10,000 clean room. A clean room prevents dust from interfering in the printing process. Dust on the pixels may prevent the pixels from contacting their underlying light guide panel. Further, dust can be collected in the adhesive prior to printing, which can clog openings in the print screen and cause incomplete pixel printing.

An effective 3 mil (0.003″) thick film (“3 mil film”) is constructed by printing a 30% halftone pixel pattern of round pixels, which are offset to each other by 45 degree angles at a 70 lines per inch resolution on a 3 mil print-treated sheet of polyester. The pixels are printed using a 330 mesh screen with a 25 micron thick resist. The resultant pixels have a thickness of 0.00065″ +/−0.00005″. A film produced under the above specifications does not produce unwanted illumination and yet can still sustain a precise image for over 20 minutes. Further, independent of the time of adhesion, this illuminated image generated by this 3 mil film can be erased by any form of mechanical separation, such as peeling.

In the prior embodiment, an illuminated image is erased by some means of mechanical separation of the illuminable film from its underlying light guide panel. Proven methods of erasure include peeling. In general, peeling cannot erase selected portions of an illuminated image. However, peeling is an excellent means of erasing the entire drawing surface image.

Another embodiment of the invention includes a magnetic pressure-sensitive light-extracting film that is erasable and usable in the drawing and tracing devices. By combining magnetism with adhesion, the partial or complete erasure of an illuminated image generated by the erasable film can be attained.

Magnetic erasure works by employing materials, either within the adhesive or directly on the surfaces of the erasable film, that are attracted to a magnetic force. This attraction enables a magnet to pull the erasable film away from its underlying light guide panel. This pulling action causes selective erasure of the image by causing the adhesive bonds between the erasable film and its underlying light guide panel to be severed.

A writing stylus with a blunt tip that includes a magnet can be used to erase an illuminated image generated by the erasable film. That stylus operates like a common wooden pencil-one end of the stylus has a conical-shaped plastic tip used to draw or trace with light; the opposite end of the stylus holds a magnet and is used to selectively erase the resultant image.

Metal powders that are susceptible to magnetism and promote light diffusion, including stainless steel powder, can combined with the adhesive component of the illuminable pressure-sensitive film, as described above, to facilitate magnetic erasure. An effective adhesive has 10% by weight nano-scale stainless steel powder. The nano-scale particles support homogenous mixing, whereas larger metal particles tend to aggregate to form light blocking layers that limit illumination.

A more cost-effective approach to making a magnetic erasable film is to print metal directly on the plastic film substrate of the illuminable pressure-sensitive film using screen printing. To print the erasable film, the metal component is added to a clear varnish to form a printable metallic ink, which is non-adhesive. The metallic ink layer is printed in a halftone pattern on the plastic film substrate prior to over-printing a halftone of light-extracting adhesive pixels.

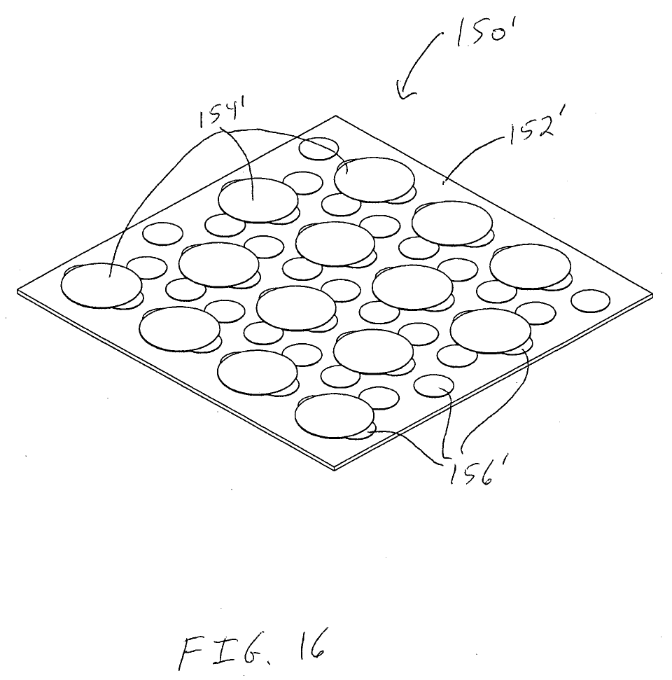

FIG. 16 is a schematic perspective view of a magnetic erasable film. The erasable film 150′ has a magnetic halftone layer 156′ printed on a polyester sheet 152′. In turn, the magnetic dots 156′ are overprinted with pixel adhesive 154′. Note that the magnetic deposits are not registered with the pixel adhesive deposits. Alternatively, a magnetic halftone layer can be printed adjacent to the pixel adhesive.

In a particular embodiment, magnetic erasable film is produced using a two-station screen printing line in which the printing specification for the adhesive pixel printing component of the erasable film is the same as the printing specification for the illuminable pressure-sensitive film described above. Printing the metallic halftone layer requires common print settings. However, the screen for printing the metallic layer will have a greater thread count, such as a 400 Mesh, to ensure the thickness of the metallic halftone layer is less than the thickness of the adhesive pixel layer in the erasable film.

To reduce the interference between the metallic halftone layer and the adhesive halftone layer, the metallic layer is printed at a much higher resolution than the adhesive layer. The resultant smaller metallic pixels are less capable of blocking the larger adhesive pixels, which are responsible for providing the illumination in the device.

A neodymium permanent magnet, encapsulated in the stylus, can be used to erase the illuminated images from the erasable film. Neodymium magnets are readily available at low-cost and can be encapsulated into a two piece stylus using heat-staking or ultrasonic welding. Because neodymium magnets can cause a severe ingestion hazard a toy embodiment of the stylus employs secondary encapsulation and must be tested.

It is understood that light guide panels having square or jagged edges between the planar surfaces can leak injected light, thus not being as efficient as possible. The above-described embodiments can be improved by employ light guides with curved or rounded edges.

A specific embodiment of rounded edge light guide incorporates a light source, such as one or more LEDs, and is includes a clear light-transmitting plastic, such as polycarbonate, acrylic, or polystyrene. Additionally, the light guide is produced via injection molding to ensure a geometry that promotes TIR by utilizing a planar shape of consistent thickness with rounded edges that further promote TIR. As a result, by efficiently capturing and distributing light, for a given light source, the light guide enables an image display device that increases light intensity (brightness) while lowering the unit cost of the device by eliminating the need for a reflector or some other light focusing device. This light guide works because light already trapped between the planar surfaces of the light guide are propagated through the light guide at incident angles that are greater that the critical angle of the light guide. Subsequently, when these trapped light rays encounter a rounded edge of the light guide reflection occurs that is incapable of producing an incident angle less than the critical angle of the light guide. Ultimately, this causes nearly all light that contacts the rounded edges to be reflected back into the light guide. This light recycling effect can be demonstrated virtually through the use of light ray modeling tools such as TracePro.

A practical version of such a light guide can be made by producing a 2.5 mm to 3.5 mm thick light guide that has round edges, i.e., edges with a radius equal to half the thickness of the light guide. This light guide comprises optical acrylic or polystyrene. Further, the light source for this light guide is one or more LEDs or a surface mounted LED chips. These light sources are positioned to emit light at sub-critical angles to minimize light loss during light injection into the light guide.

The rounded edges of the light guide maintain TIR. Because the rounded edge is produced by injection molding, a break line in the rounded edge is unavoidable. However, if this surface imperfection is located at the apex of the rounded edge, the light loss at this location is only a fraction of the overall light that is returned into the light guide by TIR. Such fabrication techniques can be used for producing light guides with rectangular or circular surfaces.

While this invention has been particularly shown and described with references to particular embodiments, it will be understood by those skilled in the art that various changes in form and details may be made to the embodiments without departing from the scope of the invention encompassed by the appended claims. For example, various features of the embodiments described and shown can be omitted or combined with each other.

What is claimed is:

1. An illuminable marking device operable in an ambient medium having an ambient index of refraction, comprising:
a light guide panel comprising a first optical material having an upper surface and a lower surface, the first material having a first index of refraction greater than the ambient index of refraction;
a light source optically coupled to the light guide panel for injecting light into light guide panel, the injected light having an angle of incidence at the upper surface and lower surface of the light guide panel sufficient to establish total internal reflection; and
an illuminable film comprising a second optical material disposed over the upper surface of the light guide panel, the second material having a second index of refraction equal to or greater than the first index of refraction, the illuminable film adherable to selected points on the upper surface of the light guide panel in response to localized pressure at the selected points, whereby adhering the illuminable film to the light guide panel optically couples the illuminable film with the light guide panel to extract injected light from the light guide panel to illuminate the illuminable film at the selected points.

2. The device of claim 1 wherein the illuminable film includes a top layer and a bottom layer.

3. The device of claim 2 wherein the bottom layer is an illuminable adhesive comprising a second material and adherable to the first material.

4. The device of claim 3 wherein the bottom layer further comprises a light-diffusing agent.

5. The device of claim 3 wherein the illuminable adhesive is arranged in a halftone pattern.

6. The device of claim 2 wherein the top layer is a film substrate comprising a third material having a third index of refraction equal to or greater than the second index of refraction.

7. The device of claim 1 wherein the illuminable film comprises a colorant.

8. The device of claim 1 wherein the light source is optically coupled to edge-illuminate the light guide panel.

9. The device of claim 8 wherein the light source comprises a plurality of colored light elements.

10. The device of claim 9 wherein the colored light elements can be selectively illuminated.

11. The device of claim 1 further comprising a mechanism for optically decoupling the illuminable film from the light guide panel.

12. The device of claim 11 wherein the mechanism mechanically separates the adhered illumination film from the upper surface of the light guide.

13. An illuminable marking device operable in an ambient medium having an ambient index of refraction, comprising:
a light guide panel comprising a first optical material having an upper surface and a lower surface, the first material having a first index of refraction greater than the ambient index of refraction;
a light source optically coupled to the light guide panel for injecting light into the light guide panel, the injected light having an angle of incidence at the upper surface and lower surface of the light guide panel sufficient to establish total internal reflection;
an illuminable film disposed over the upper surface of the light guide panel, the illuminable film comprising:
a bottom layer comprising an illuminable adhesive, the illuminable adhesive having a second index of refraction equal to or greater than the first index of refraction, the illuminable adhesive adherable to selected points on the upper surface of the light guide panel in response to localized pressure at the selected points, whereby adhering the illuminable adhesive to the light guide panel optically couples the illuminable adhesive with the light guide panel to extract injected light from the light guide panel; and
a top layer comprising a second optical material disposed over the bottom layer, the second optical material having a third index of refraction equal to or greater than the second index of refraction to transmit extracted injected light from the illuminable adhesive to illuminate the second optical material at the selected points.

14. The device of claim 13 wherein the illuminable adhesive comprises a light-diffusing agent.

15. The device of claim 14 wherein the light-diffusing agent is titanium dioxide.

16. The device of claim 13 wherein the illuminable adhesive is arranged in a halftone pattern on the optical film substrate.

17. The device of claim 13 wherein the first optical material and the illuminable adhesive comprise an acrylic material.

18. The device of claim 13 wherein the second optical material is a plastic film and the plastic is selected from the group consisting of polyester, acetate, acrylic, and polycarbonate.

19. The device of claim 13 wherein the light source is optically coupled to edge-illuminate the light guide panel.

20. The device of claim 20 wherein the light source comprises a plurality of colored light elements.

21. The device of claim 21 wherein the colored light elements can be selectively illuminated.

22. The device of claim 13 further comprising a mechanism for optically decoupling the illuminable film from the light guide panel.

23. The device of claim 23 wherein the mechanism mechanically separates the adhered illumination film from the upper surface of the light guide.

24. An illuminable marking device operable in an ambient medium having an ambient index of refraction, comprising:
a light guide panel comprising a first optical material having an upper surface and a lower surface, the first material having a first index of refraction greater than the ambient index of refraction;
a light source optically coupled to the light guide panel for edge-illuminating the light guide panel with injected light, the injected light having an angle of incidence at the upper surface and lower surface of the light guide panel sufficient to establish total internal reflection;
an illuminable film disposed over the upper surface of the light guide panel, the illuminable film comprising:
a bottom layer comprising an illuminable adhesive arranged in a halftone pattern of pixels, the illuminable adhesive including a light-diffusing agent and having a second index of refraction equal to or greater than the first index of refraction, the illuminable adhesive pixels adherable to selected points on the upper surface of the light guide panel in response to localized pressure at the selected points, whereby adhering the illuminable adhesive pixels to the light guide panel optically couples the illuminable adhesive pixels with the light guide panel to extract injected light from the light guide panel;
a top layer comprising a second optical material disposed over the bottom layer, the second optical material having a third index of refraction equal to or greater than the second index of refraction to transmit extracted injected light from the illuminable adhesive pixels to illuminate the second optical material at the selected points; and
a mechanism for optically decoupling the adhesive pixels from the light guide panel.

25. The device of claim 24 wherein the light-diffusing agent is titanium dioxide.

26. The device of claim 24 wherein the first optical material and the illuminable adhesive comprise an acrylic material.

27. The device of claim 24 wherein the second optical material is a plastic film.

28. The device of claim 27 wherein the plastic film comprises a plastic selected from the group consisting of polyester, acetate, acrylic, and polycarbonate.

29. The device of claim 24 wherein the light source comprises a plurality of colored light elements.

30. The device of claim 29 wherein the colored light elements can be selectively illuminated.

31. The device of claim 24 wherein the mechanism mechanically separates the adhered illuminable adhesive pixels from the upper surface of the light guide.

32. An illuminable film for extracting light from an active light guide panel having a first index of refraction, the illuminable film comprising:
a bottom layer comprising an illuminable adhesive, the illuminable adhesive having a second index of refraction equal to or greater than the first index of refraction, the illuminable adhesive adherable to selected points on a light guide panel in response to localized pressure at the selected points, whereby adhering the illuminable adhesive to the light guide panel optically couples the illuminable adhesive with the light guide panel to extract light from the light guide panel; and
a top layer comprising a second optical material disposed over the bottom layer, the second optical material having a third index of refraction equal to or greater than the second index of refraction to transmit extracted light from the illuminable adhesive to illuminate the second optical material at the selected points.

33. The illuminable film of claim 32 wherein the illuminable adhesive comprises a light-diffusing agent.

34. The illuminable film of claim 33 wherein the light-diffusing agent is titanium dioxide.

35. The illuminable film of claim 32 wherein the illuminable adhesive is arranged in a halftone pattern on the top layer.

36. The illuminable film of claim 32 wherein the illuminable adhesive comprise an acrylic material.

37. The illuminable film e of claim 32 wherein the second optical material is a plastic film.

38. The illuminable film of claim 35 wherein the plastic film comprises a plastic selected from the group consisting of polyester, acetate, acrylic, and polycarbonate.

39. The illuminable film of claim 32 further comprising a layer of a magnetic material disposed between the bottom layer and the top layer.

40. The illuminable film of claim 39 wherein the magnetic material is arranged in a halftone pattern on the top layer.

41. A method of fabricating an illuminable marking device operable in an ambient medium having an ambient index of refraction, the method comprising:
fabricating a light guide panel comprising a first optical material having an upper surface and a lower surface, the first material having a first index of refraction greater than the ambient index of refraction;
optically coupling a light source to the light guide panel for injecting light into light guide panel at an angle of incidence at the upper surface and lower surface of the light guide panel sufficient to establish total internal reflection; and
fabricating an illuminable film comprising a second optical material, the second material having a second index of refraction equal to or greater than the first index of refraction;
disposing the illuminable film over the upper surface of the light guide panel, the illuminable film adherable to selected points on the upper surface of the light guide panel in response to localized pressure at the selected points, whereby adhering the illuminable film to the light guide panel optically couples the illuminable film with the light guide panel to extract injected light from the light guide panel to illuminate the illuminable film at the selected points.

42. The method of claim 41 wherein fabricating the illuminable film includes fabricating a top layer and a bottom layer.

43. The method of claim 42 wherein fabricating the bottom layer comprises applying an illuminable adhesive comprising a second material and adherable to the first material.

44. The method of claim 43 wherein fabricating the bottom layer further comprises applying a light-diffusing agent.

45. The method of claim 43 wherein applying the illuminable adhesive comprises arranging the illuminable adhesive in a halftone pattern.

46. The method of claim 42 wherein fabricating the top layer comprises fabricating a film substrate comprising a third material having a third index of refraction equal to or greater than the second index of refraction.

47. The method of claim 41 wherein fabricating the illuminable film comprises applying a colorant.

48. The method of claim 41 wherein the light source is optically coupled to edge-illuminate the light guide panel.

49. The method of claim 48 wherein the light source comprises a plurality of colored light elements.

50. The method of claim 49 wherein the colored light elements can be selectively illuminated.

51. The method of claim 41 further comprising fabricating a mechanism for optically decoupling the illuminable film from the light guide panel.

52. The method of claim 51 wherein the mechanism mechanically separates the adhered illumination film from the upper surface of the light guide.

53. A method of fabricating an illuminable marking device operable in an ambient medium having an ambient index of refraction, the method comprising:
fabricating a light guide panel comprising a first optical material having an upper surface and a lower surface, the first material having a first index of refraction greater than the ambient index of refraction;
optically coupling a light source to the light guide panel for injecting light into the light guide panel at an angle of incidence at the upper surface and lower surface of the light guide panel sufficient to establish total internal reflection;
fabricating an illuminable film, comprising:
fabricating a bottom layer comprising an illuminable adhesive, the illuminable adhesive having a second index of refraction equal to or greater than the first index of refraction;
fabricating a top layer comprising a second optical material, the second optical material having a third index of refraction equal to or greater than the second index of refraction;
disposing the bottom layer on the top layer; and
disposing the illuminable film over the upper surface of the light guide panel, such that the illuminable adhesive is adherable to selected points on the upper surface of the light guide panel in response to localized pressure at the selected points, whereby adhering the illuminable adhesive to the light guide panel optically couples the illuminable adhesive with the light guide panel to extract injected light from the light guide panel.

54. A method of fabricating an illuminable marking device operable in an ambient medium having an ambient index of refraction, the method comprising:
fabricating a light guide panel comprising a first optical material having an upper surface and a lower surface, the first material having a first index of refraction greater than the ambient index of refraction;
optically coupling a light source to the light guide panel for edge-illuminating the light guide panel with injected light at an angle of incidence at the upper surface and lower surface of the light guide panel sufficient to establish total internal reflection;
fabricating an illuminable film, comprising:
fabricating a bottom layer comprising an illuminable adhesive arranged in a halftone pattern of pixels, the illuminable adhesive including a light-diffusing agent and having a second index of refraction equal to or greater than the first index of refraction;
fabricating a top layer comprising a second optical material, the second optical material having a third index of refraction equal to or greater than the second index of refraction; and
disposing the bottom layer on the top layer;
disposing the illuminable film over the upper surface of the light guide panel, such that the illuminable adhesive pixels are adherable to selected points on the upper surface of the light guide panel in response to localized pressure at the selected points, whereby adhering the illuminable adhesive pixels to the light guide panel optically couples the illuminable adhesive pixels with the light guide panel to extract injected light from the light guide panel; and
attaching a mechanism for optically decoupling the adhesive pixels from the light guide panel.

55. A method of fabricating an illuminable film for extracting light from an active light guide panel having a first index of refraction, the method comprising:
fabricating a bottom layer comprising an illuminable adhesive, the illuminable adhesive having a second index of refraction equal to or greater than the first index of refraction;
fabricating a top layer comprising a second optical material, the second optical material having a third index of refraction equal to or greater than the second index of refraction; and
disposing the bottom layer on the top layer.

56. The method of claim 55 wherein the illuminable adhesive comprises a light-diffusing agent.

57. The method of claim 56 wherein the light-diffusing agent is titanium dioxide.

58. The method of claim 55 wherein the illuminable adhesive is arranged in a halftone pattern on the top layer.

59. The method of claim 55 wherein the illuminable adhesive comprise an acrylic material.

60. The method of claim 55 wherein the second optical material is a plastic film.

61. The method of claim 60 wherein the plastic film comprises a plastic selected from the group consisting of polyester, acetate, acrylic, and polycarbonate.

62. The method of claim 55 further comprising a layer of a magnetic material disposed between the bottom layer and the top layer.

63. The method of claim 62 wherein the magnetic material is arranged in a halftone pattern on the top layer.
